(19) United States
(12) Patent Application Publication
(10) Pub. No.: US 2007/0288951 A1
(43) Pub. Date: Dec. 13, 2007

(54) INCENTIVES FOR VIEWING ADVERTISEMENTS

(75) Inventors: James T. Ray, San Francisco, CA (US); Kevin J. Knowles, San Francisco, CA (US); Michael Lasevich, Oakland, CA (US); Osvaldo Espaillat, San Rafael, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: First Data Corporation, Greenwood Village, CO (US); Size Technologies, Inc., San Francisco, CA (US)

(21) Appl. No.: 11/742,342

(22) Filed: Apr. 30, 2007

Related U.S. Application Data
(60) Provisional application No. 60/745,998, filed on Apr. 28, 2006.

(51) Int. Cl. H04N 7/16

(52) U.S. Cl. 725/23

(57) ABSTRACT

An incentive system for viewing commercials can be used to provide incentives to consumers to view commercials rather than avoiding the commercials through the use of electronic devices. In accordance with one embodiment, the incentive system can reward a consumer to play a commercial that the consumer would not normally play. This is of use for example in a personal video recorder that normally can be configured to eliminate commercials; yet, in accordance with one embodiment can be configured to assist as part of the incentive system to optionally display commercials when a consumer is willing to play the commercial. Feedback about specific commercials can also be obtained from a consumer in accordance with one embodiment. And, reports about particular commercials can be generated and supplied to advertisers and broadcasters, for example.

### CROSS-REFERENCES TO RELATED APPLICATIONS

This application claims the benefit under 35 USC 119(e) of U.S. Patent Application No. 60/745,998, filed Apr. 28, 2006, “Incentives for Viewing Advertisements”, which is hereby incorporated by reference, as if set forth in full in this document, for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND

Electronic devices such as the personal video recorder (PVR) have significantly affected the ability of advertisers to place their commercials in front of a captive audience. Such devices allow consumers to record television programs and play the programs back without the watching of the embedded commercials. Even video cassette recorders (VCR's) which have been around for quite some time have affected the ability of advertisers to capture the attention of a traditional television audience in that VCR's allow one to fast forward past a commercial during playback of the recorded program. As a result, advertisers are losing access to millions of viewers of their commercials.

As electronic devices such as PVR's increase in use in the future, it can be expected that advertisers will place less value on distributing advertisements via the broadcast media and will focus their advertising budgets elsewhere. This will impact broadcasters who rely on advertising revenue, since the advertisers will be less willing to pay advertising rates given the fact that it is now less likely that a consumer will actually see a commercial included as part of a broadcast due to devices such as the PVR.

While advertisements are often entertaining, they are usually not something that a consumer desires to watch. As a result, consumers will not typically spend time watching advertisements if there is more desirable programming available or other options available to occupy the consumer's time. Thus, even when a consumer does not possess the technology to bypass broadcast commercials, the consumer might simply turn his/her attention to another task until the commercial is over. Therefore, the advertising message is not successfully conveyed in this situation, as well.

Consequently, advertisers and broadcasters are in need of a system that will provide incentive for consumers to view commercial advertisements.

### SUMMARY

In accordance with one embodiment of the invention, a method can be implemented for providing incentives to consumers to view advertisements, such as television commercials. The method can be implemented by registering a consumer in an incentive program, the incentive program configured to incite a consumer to play an advertisement; transmitting program content comprising non-commercial content and a commercial to a content receiver operated by a consumer, wherein the content receiver is configured to store the non-commercial content as stored non-commercial content and configured to store the commercial as a stored commercial for later playback; determining that the consumer played the stored commercial; and crediting to the consumer an incentive program credit in return for the consumer playing the commercial.

In accordance with another embodiment of the invention, a method of registering consumers in an incentive program that provides incentives to view commercials can be implemented by registering a consumer in an incentive program; providing the consumer with a list of categories of commercials that the consumer can view under the incentive program; receiving from the consumer a set of selected categories of commercials; associating the set of selected categories of commercials with an identifier for the consumer in a computer database.

In yet another embodiment of the invention, a method of allowing a consumer to optionally select commercials for viewing can be implemented by receiving program content comprising non-commercial content and a commercial at a content receiver operated by a consumer, wherein the content receiver is configured to store the non-commercial content as stored non-commercial content and configured to store the commercial as a stored commercial for later playback; querying the consumer during playback of the non-commercial content as to whether the consumer wants to play the stored commercial; determining that the consumer has selected playback of the stored commercial; and playing the stored commercial.

In still another embodiment of the invention, feedback about a particular commercial can be obtained by registering a consumer in an incentive program, the incentive program configured to incite the consumer to play an advertisement; transmitting program content comprising non-commercial content and a commercial to a content receiver operated by a consumer, wherein the content receiver is configured to store the non-commercial content as stored non-commercial content and configured to store the commercial as a stored commercial for later playback; and receiving immediate feedback from the consumer in response to playback of the stored commercial.

Another embodiment of the invention provides a redemption system for an incentive system that encourages a user to watch a commercial. The method can be implemented, for example, by registering a consumer in an incentive program, the incentive program configured to incite the consumer to play an advertisement; crediting the consumer with incentive program credit in response to the consumer playing the advertisement; and redeeming the incentive program credit.

Further embodiments of the invention will be apparent from the specification and claims.

### BRIEF DESCRIPTION OF THE DRAWINGS

FIG. 1 illustrates a block diagram of a content distribution system that can be utilized in accordance with one embodiment of the invention.

FIG. 2 illustrates a block diagram of a computer that can be utilized to implement the devices shown in FIG. 1 in accordance with one embodiment of the invention.

FIG. 3 illustrates a flow chart demonstrating a method of providing incentive to a consumer to view a commercial advertisement in accordance with one embodiment of the invention.

FIGS. 4A and 4B illustrate a flow chart demonstrating a method of providing incentive and distribution of incentive credit in accordance with one embodiment of the invention.

FIG. 5 illustrates a flow chart demonstrating a method of registering a participant in an incentive program for viewing broadcast advertisements in accordance with one embodiment of the invention.

FIGS. 6A and 6B illustrate a flow chart demonstrating a method of registering a participant in an incentive program and reporting out results of the incentive program in accordance with one embodiment of the invention.

FIGS. 7A and 7B illustrate a flow chart demonstrating a method of confirming that a consumer has played back a commercial as part of an incentive program, in accordance with one embodiment of the invention.

FIG. 8 illustrates a flow chart demonstrating a method of providing feedback about a commercial advertisement in accordance with one embodiment of the invention.

FIG. 9 illustrates a flow chart demonstrating a method of crediting a consumer under an incentive program for playing a commercial advertisement, in accordance with one embodiment of the invention.

FIG. 10 illustrates a diagram of an incentive program in accordance with one embodiment of the invention.

### DETAILED DESCRIPTION

In accordance with a present embodiment of the invention, a system is utilized that provides incentive to a consumer to view advertisements such as television commercials. The thought that a consumer would want to watch a commercial is contrary to human nature in that most consumers have no desire to view commercials. In fact, devices such as personal video recorders and video cassette recorders are often used by consumers to reduce or completely eliminate such commercials during playback of a recorded program. The present embodiment of the invention therefore can be beneficial in that it incites (i.e., provides incentive) to a consumer to play a commercial. Similarly, it can be beneficial to broadcasters that broadcast such advertisements in order to obtain revenue. There also can be secondary effects on the program content providers in that such program content providers can charge a higher price for their program content, when such program content is broadcast on a system that is underwritten by television advertising.

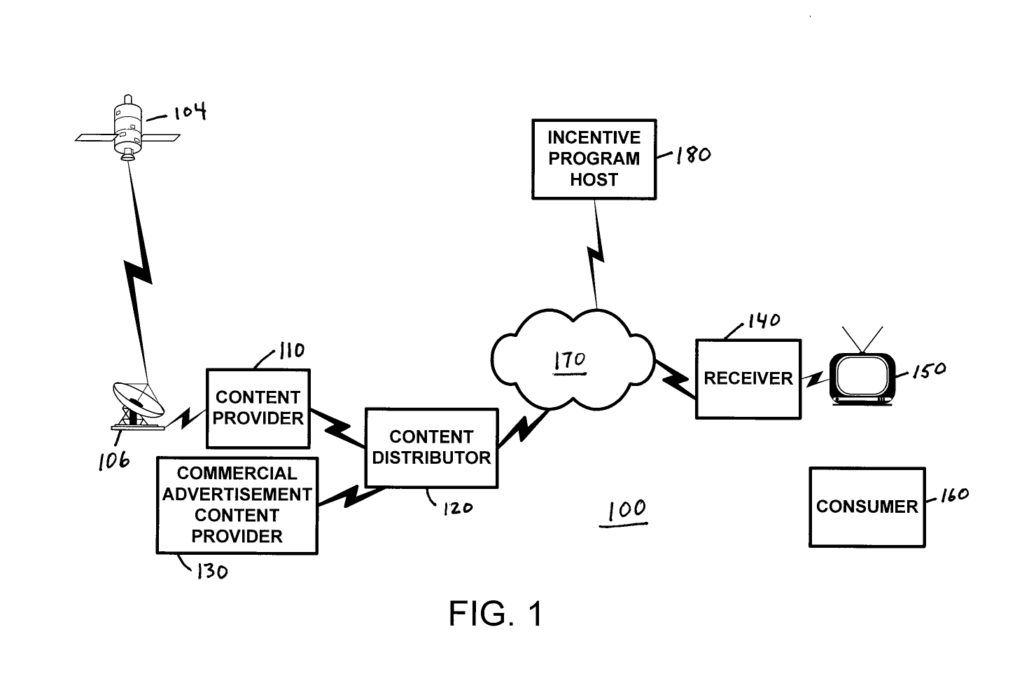

One example of such an incentive system can be seen in FIG. 1. FIG. 1 shows an incentive system 100. A content provider 110 provides non-commercial program content to a broadcaster 120. Similarly, the broadcaster can obtain commercial content from an advertiser 130. The content provider can obtain the non-commercial program content from a variety of sources. As one example, a satellite transmission of a sporting event, for example, can be transmitted from a satellite 104 to a satellite receiver 106. The broadcaster combines the non-commercial program content with the commercial content such that the commercials are intermittently inserted within the non-commercial program content. For example, during live sporting events, the broadcaster might insert commercials during stoppage of play.

The combined content can be broadcast to receivers operated by consumers, such as receiver 140 operated by consumer 160. If the content is audio-visual, the consumer can view the content on display 150. If the content is purely audio, the user can play the content on an audio player.

The transmission of the content can take place across a network, such as network 170, or across the atmosphere. Furthermore, the receiver can also operate as a transmitter so as to send return signals in some instances to another part of the incentive system. For example, such transmission could be used to indicate that the consumer has watched a commercial or to provide feedback from the consumer about a commercial or product.

FIG. 1 also shows an incentive program host 180. Incentive program host can be coupled with any of the following: the advertiser 130, the consumer receiver 140, and/or the broadcaster 120. By communicating with the consumer, for example, the incentive program host can register the consumer as a participant in the incentive program. The incentive program host can also obtain feedback from the consumer as to how the consumer felt about a particular advertisement or whether the consumer actually played a commercial advertisement. The incentive program host can also perform redemption of incentive credits.

The system of FIG. 1 allows a consumer to register with the incentive program for purposes of receiving some form of value in return for playing a stored commercial. For example, when a consumer records a sporting event on his/her personal video recorder, that recorded sporting event can typically be played back without having to watch the commercials. However, the incentive program system shown in FIG. 1 would provide the consumer with some form of value when the consumer actually does watch the recorded commercials. The length of time spent viewing the commercials or the number of commercials played, for example, can then be reported back by the consumer's receiver 140 to the incentive program host 180. Under predetermined incentive program rules, the incentive program host can then credit the consumer's incentive program account with a corresponding value. For example, the incentive program might provide a consumer's account with a point for every commercial that is viewed. As another example, the incentive program might provide the consumer's account with 3 minutes worth of time toward a predetermined number of minutes required to receive a reward. In such an example, a consumer might be required to view 30 minutes of commercials before being eligible for a reward.

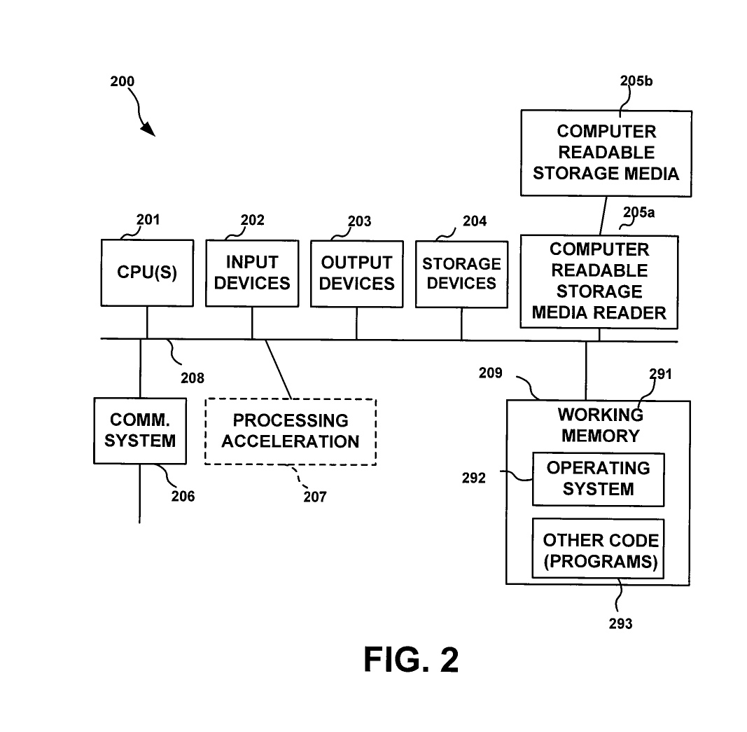

FIG. 2 broadly illustrates how individual system elements of the system shown in FIG. 1 can be implemented. System 200 is shown comprised of hardware elements that are electrically coupled via bus 208, including a processor 201, input device 202, output device 203, storage device 204, computer-readable storage media reader 205a, communications system 206 processing acceleration (e.g., DSP or special-purpose processors) 207 and memory 209. Computer-readable storage media reader 205a is further coupled to computer-readable storage media 205b, the combination comprehensively representing remote, local, fixed and/or removable storage devices plus storage media, memory, etc. for temporarily and/or more permanently containing computer-readable information, which can include storage device 204, memory 209 and/or any other such accessible system 200 resource. System 200 also comprises software elements (shown as being currently located within working memory 291) including an operating system 292 and other code 293, such as programs, applets, data and the like.

System 200 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 200 component (e.g. within communications system 206). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized.

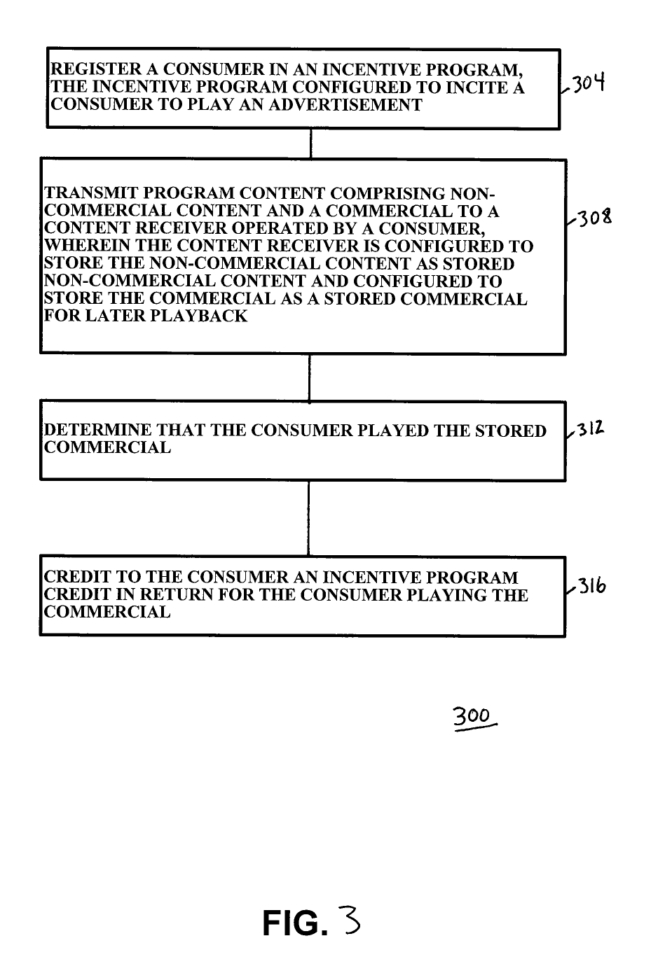

FIG. 3 illustrates an example of implementing an incentive system for viewing commercials in accordance with one embodiment of the invention. In block 304 of flow chart 300, a consumer registers with an incentive program. More specifically, the consumer registers with an incentive program that is configured to reward the consumer for playing commercial advertisements, such as viewing television ads, or listening to radio ads, etc. In block 308, program content is transmitted to a content receiver. The program content can be comprised of non-commercial content (i.e., content not primarily for purposes of advertising, such as a sporting event or movie) and a commercial (e.g., a pet food commercial). The receiver is configured to store the non-commercial content and the commercial for later playback. For example, a personal video recorder such as a TIVO system is configured to store such data.

Upon playback of the program content, a determination can be made as to whether the consumer actually played the commercial, as shown in block 312. For example, this can be implemented by using software stored on a personal video recorder to determine whether the consumer played an identified commercial or skipped over the identified commercial. Similarly, the consumer can be presented with an option of viewing an identified commercial by the personal video recorder. If the user selects not to view the presented commercial, then the PVR can report that that commercial was not played. However, when a consumer does play a commercial, then the consumer's account can be credited with an incentive program credit, as shown by block 316. This effectively provides some type of value to the consumer for playing the commercial. It should be noted that even credit towards a reward threshold is understood to be of value to a consumer.

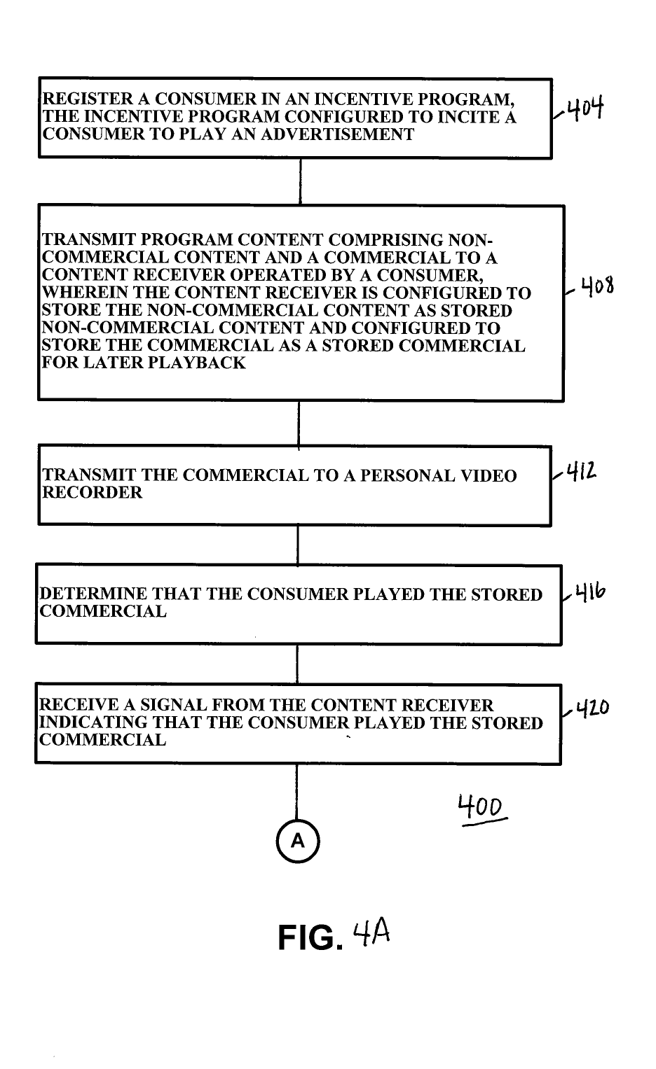

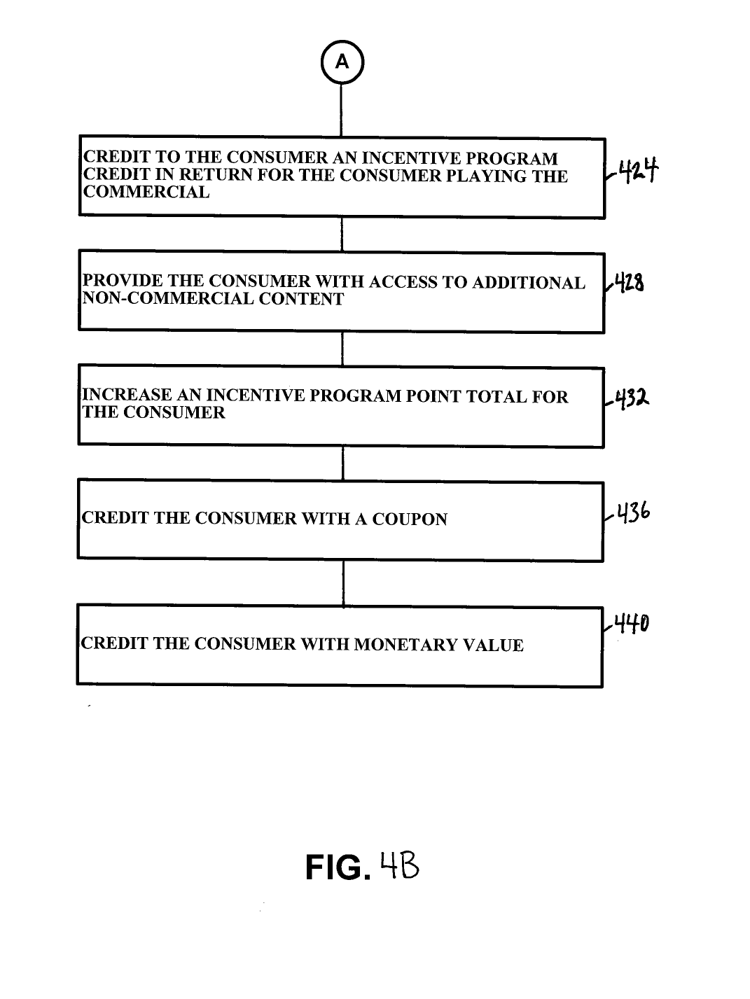

FIGS. 4A and 4B illustrate another example similar to FIG. 3. In flow chart 400, a consumer is registered as part of an incentive program in accordance with block 404. The incentive program is configured to provide an incentive to a consumer to play an advertisement, such as a television commercial or a radio advertisement. In block 408, program content is transmitted to a content receiver. The program content is comprised of non-commercial content as well as at least one commercial. The content receiver stores the received content for playback at a later time. For example, as shown in block 412, the commercial (and non-commercial) content can be transmitted to a personal video recorder. The consumer watching the commercial content can then be prompted as to whether he or she wants to view a commercial and receive credit under the incentive program. If the consumer chooses to play the commercial, the personal video recorder can make a record of that event for reporting to the incentive program. If the consumer does not choose to play the program, then the non-commercial content can continue to be played. This is illustrated by block 416. In block 420, the content receiver, e.g., the PVR, can report the consumer's behavior to the incentive program host. For example, the PVR can be coupled with a network such as the internet to transmit a message to the incentive program host. The message can indicate whether the consumer played a particular commercial, how many commercials a consumer played, the number of minutes of commercials that a consumer watched, or some other alternative measurement that the incentive program tracks in regard to commercials that were played by the consumer. In block 424, the consumer can then be credited with some type of credit in return for the consumer playing a commercial. For example, block 428 shows that the consumer could be provided with access to additional non-commercial content—for example, extra footage from the making of a movie that the consumer is currently viewing. Or, the consumer's incentive account could be credited with a predetermined number of points that are awarded for watching a television commercial, as shown by block 432. As another example, the consumer could be provided with a coupon, as shown by block 436. Or, the consumer could be credited with monetary value, such as cash in a cash account or credit redeemable from an incentive account or a discount applicable to a consumer's cable television account.

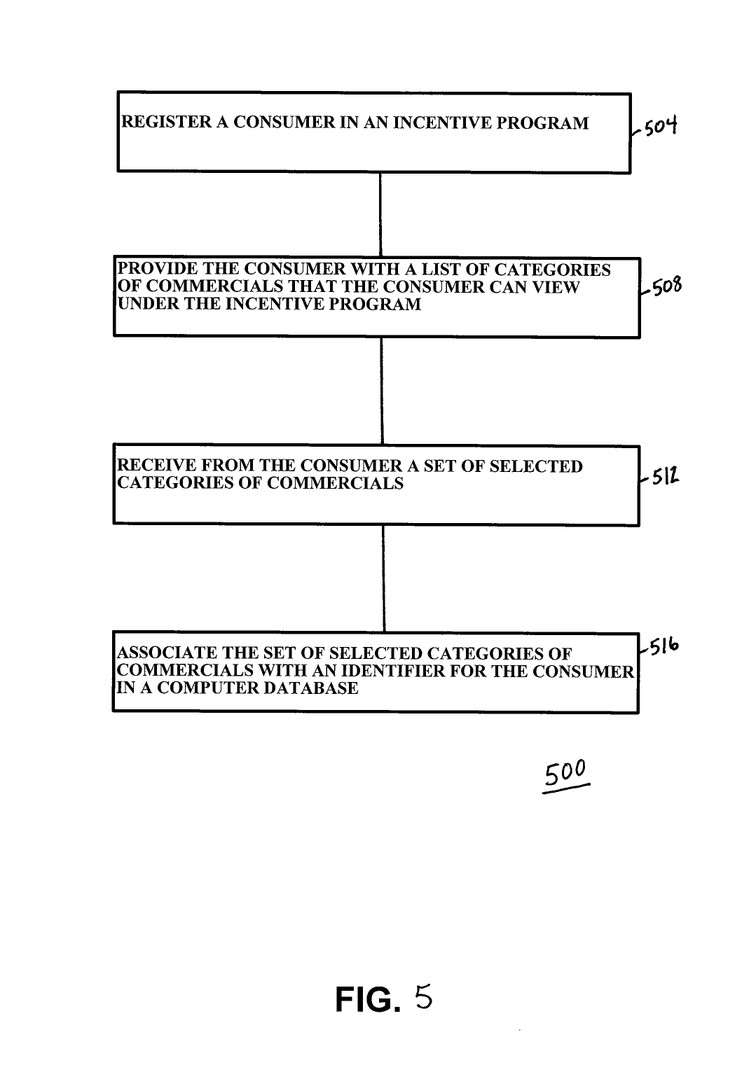

In accordance with another embodiment of the invention, one can allow a user to register his or her commercial preferences. This will facilitate the inclusion of commercials in a broadcast that appeal to certain users, thus making it more likely that those consumers will watch the commercials. FIG. 5 illustrates a flowchart 500 that demonstrates a method in accordance with one embodiment of the invention for allowing consumers to select categories of commercials that they prefer. In block 504, a consumer registers as part of an incentive program and accepts the incentive program's rules and conditions. Furthermore, the consumer is provided with a list of categories of commercials that the consumer can view in accordance with the incentive program, as shown by block 508. In block 512, the consumer submits to the incentive program a set of selected categories of commercials. Then, the incentive program associates this set of selected commercial categories with the consumer's identity in a computer database, as shown by block 516.

In addition to allowing the consumer to select categories of commercials that interest the consumer for purposes of creating a profile, the consumer's profile can be established based on the consumer's purchase history or personal demographics.

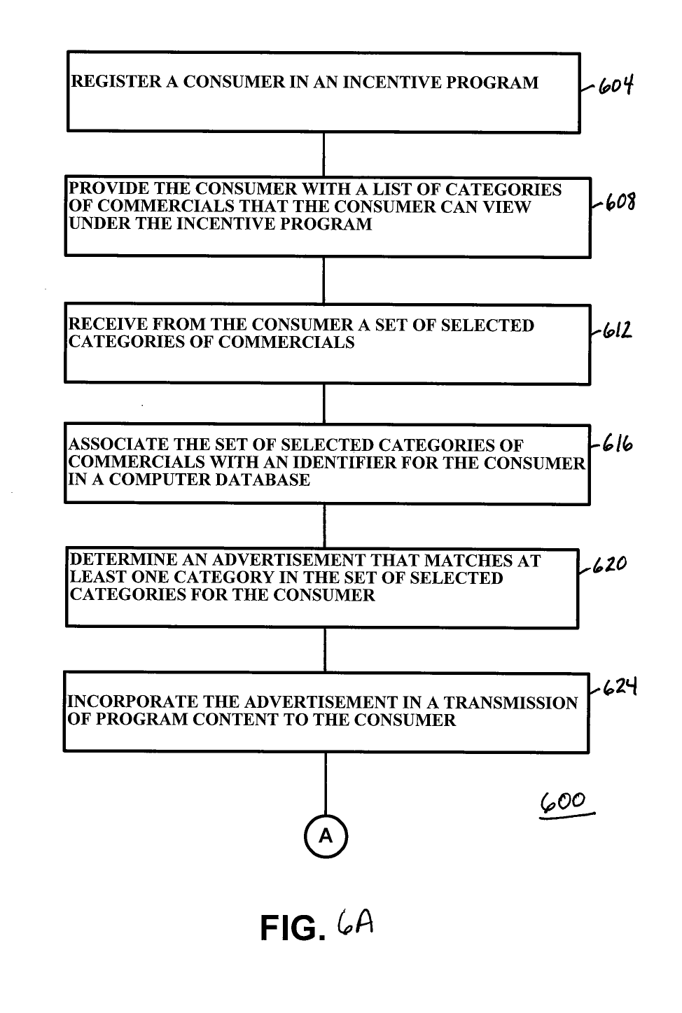

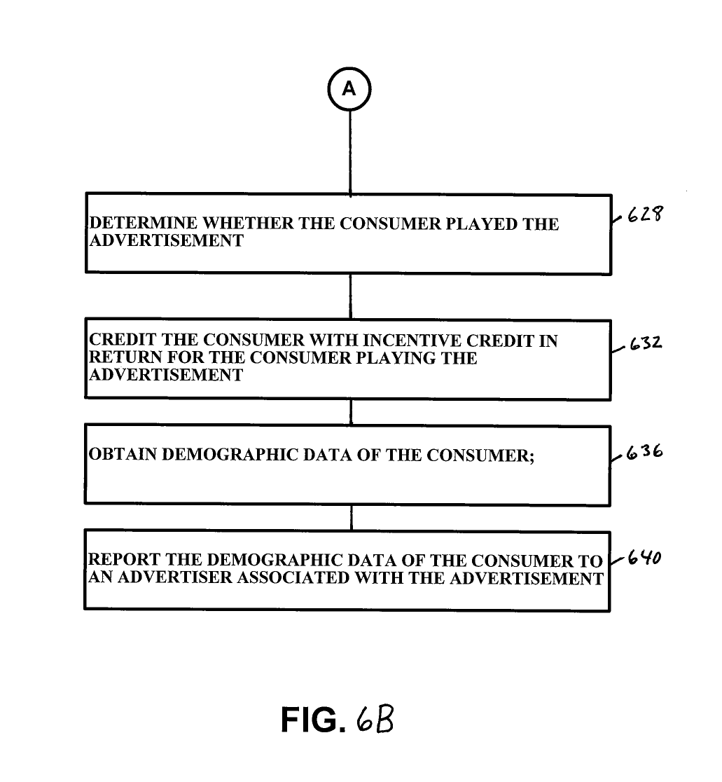

FIGS. 6A and 6B illustrate a more detailed example of a registration procedure that can be used to capture a consumer's preferences for commercials that the consumer is willing to view, in accordance with one embodiment of the invention. In block 604, an incentive program registers a consumer as a participant in the incentive program. In block 608, the consumer is provided with a list of categories of commercials to choose from. The consumer can choose from these categories the types of commercials that the consumer is willing to watch in accordance with the rules of the incentive program. In block 612, the incentive program receives a set of selected categories from the consumer. The incentive program can then associate the set of selected categories with an identifier for the consumer in a computer database, as shown by block 616.

In preparing content for broadcast to the consumer, a broadcaster or other entity can use the consumer's profile to select commercials to transmit to the consumer. For example, in preparing a transmission to a consumer that is willing to watch pet food and soup commercials, the broadcaster can transmit pet food and soup commercials to that consumer. Thus, a match is made between an available commercial for broadcast and a selected category in the consumer's profile, as indicated by block 620. In block 624, the selected commercial can then be incorporated in a transmission of program content to the consumer. A determination can then be made as to whether the consumer played the commercial, as shown by block 628. If played, the consumer can earn incentive program credit in accordance with the incentive program rules and conditions, as shown by block 632.

As another example, a profile creation process could be implemented as follows. A viewer uses his/her personal video recorder to contact an incentive program via an open network such as the internet The consumer indicates that he/she is willing to participate in the program. The consumer provides some contact information, activities, and demographic data to the incentive program. The consumer provides some personal preferences regarding products or advertisements he/she is willing to watch. The profile may then be updated over time based on the consumer's commercial viewing behavior or purchase history.

Use of a profile of commercials that a consumer is willing to view is useful in that it provides useful demographic data about the consumer. For example, by obtaining the consumer's date of birth, sex, and income level, the incentive program can provide advertisers with useful demographic data about consumers, as indicated by block 636. Thus, this demographic data can be reported to various advertisers, as shown by block 640. Furthermore, it can also allow the incentive program to tabulate how many people watched a particular commercial or category of commercial. Thus, it would provide to a broadcaster useful data in determining how much to charge advertisers for certain types of commercials. For example, if the incentive program data showed that beverage commercials are more popular with consumers than household cleaning product commercials, a broadcaster could charge an advertising company more for transmitting the beverage commercial because the audience viewing that type of commercial would be known to be larger and thus of greater benefit to the advertiser.

The selection of commercials to display to the consumer can be performed dynamically based on the consumer's most recent profile. The dynamic creation can be performed when the content program is distributed to the consumer's receiver or by the consumer's receiver itself. Thus, for example, the consumer's PVR could determine which advertisements are likely to be appealing to a viewer and dynamically configure the order and content of a commercial segment.

An example of a PVR dynamically creating a commercial block could be implemented as follows. The consumer's profile is stored on a database at the incentive program host. The incentive program host downloads the consumers profile to the PVR or other receiver operated by the consumer. An advertiser provides a commercial with meta-information about a subject, target demographic and rules in regard to usage of points. The primary content provider creates content with designated commercial breaks. The primary content provider sets price in “points per second” for commercial space in the content. A commercial is delivered to the viewing device of the consumer and stored. This could be accomplished in-line with program content or ahead of time. It could also be accomplished over a network or dedicated/leased programming channel. The commercial can be stored with meta-information for later playback at the consumer's receiver. Primary content is delivered to the viewing device with meta-information about the type of programming and available spots as well as price per second in points of various timeslots. The viewing device decides which commercials to show based on viewer profile combined with available commercial meta-information.

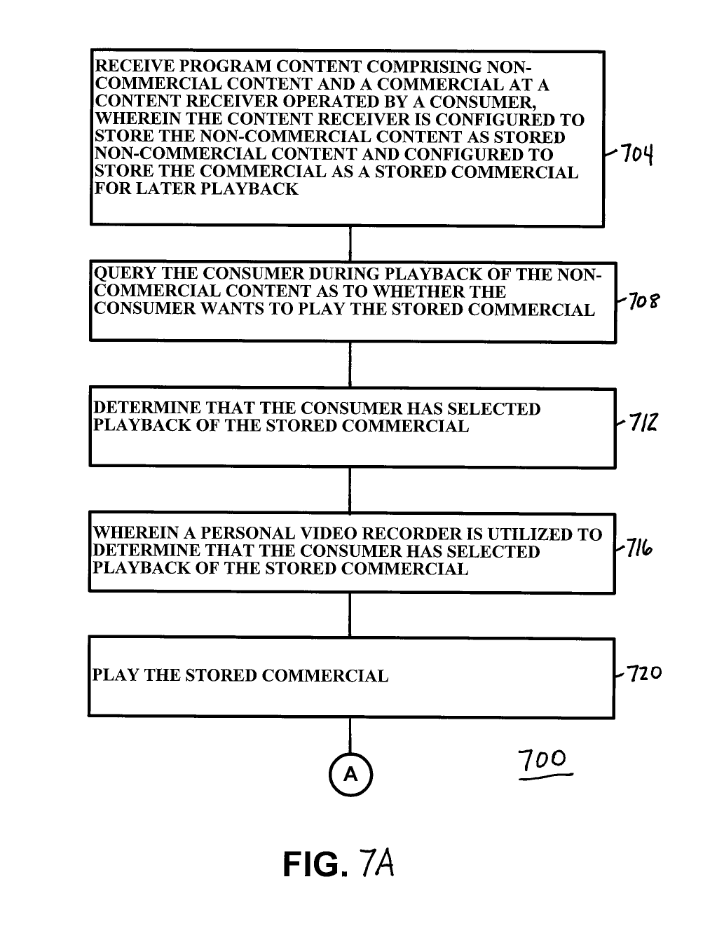

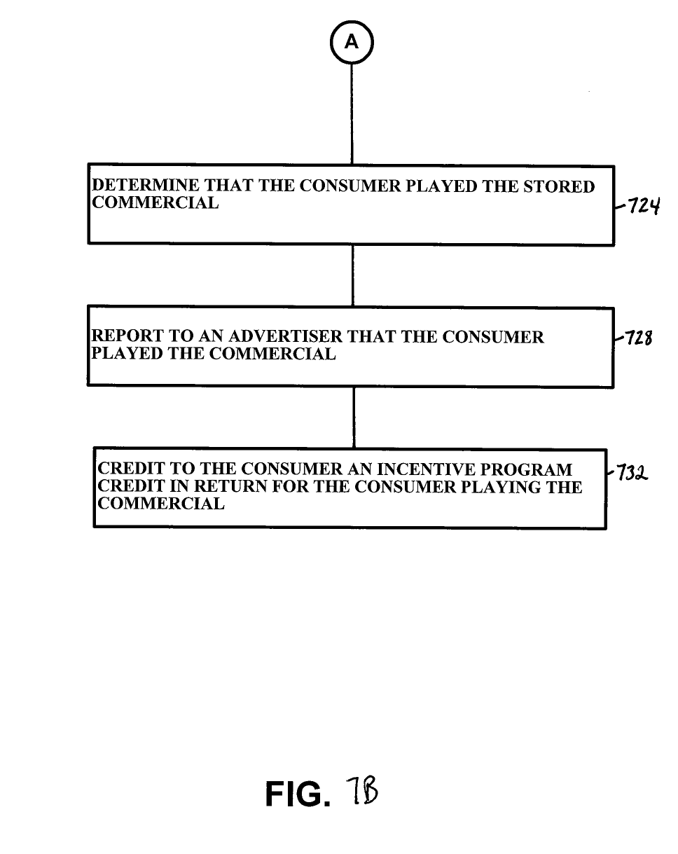

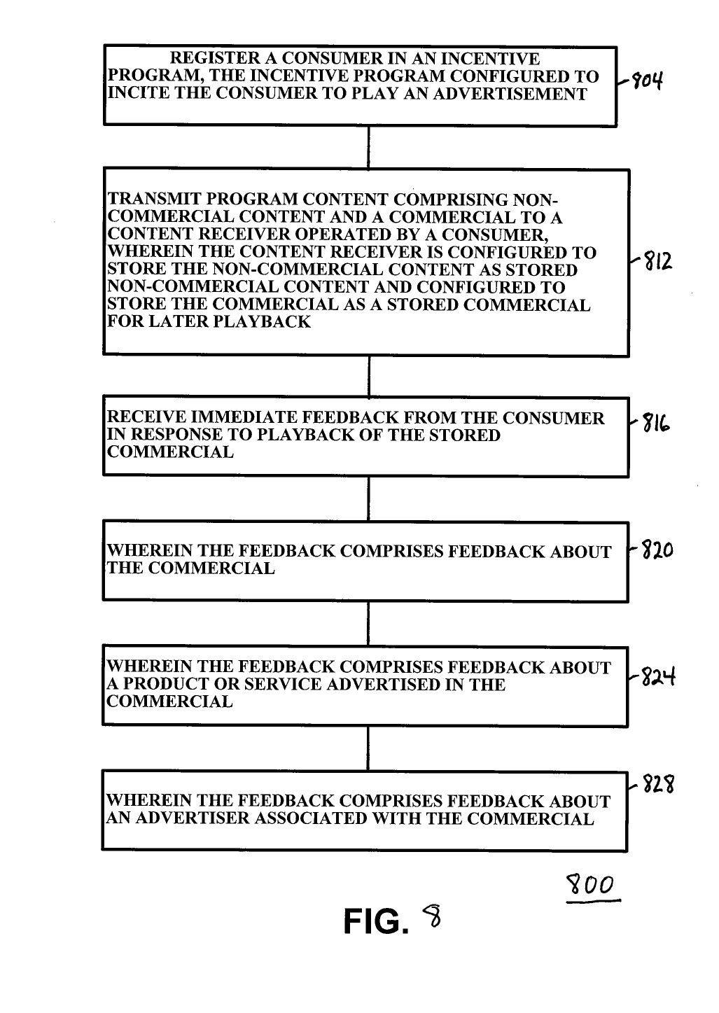

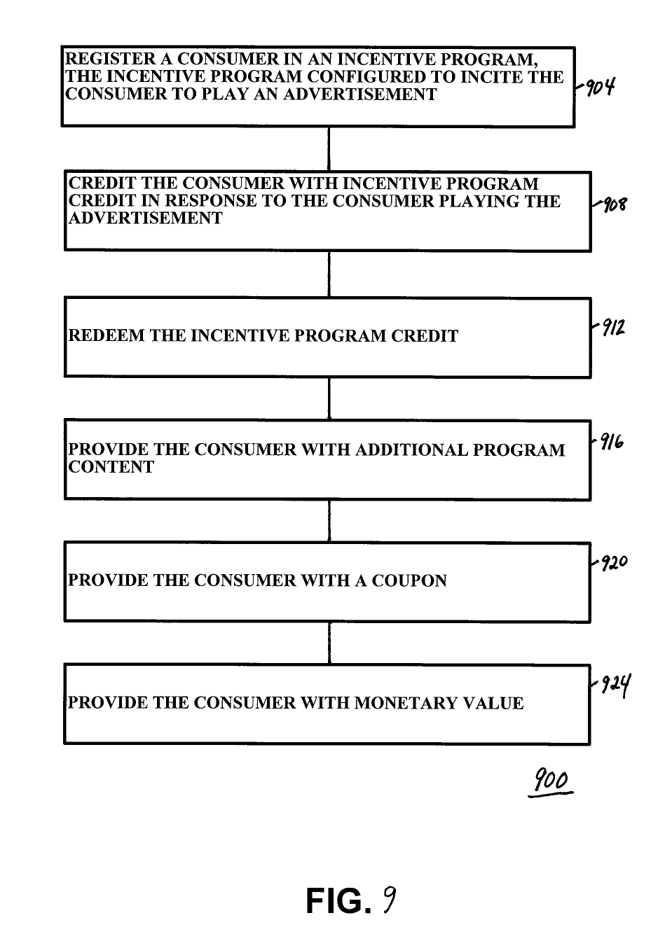

In accordance with another embodiment of the invention, a system is provided that provides a consumer with the option of viewing a commercial during playback of recorded program content. This allows a consumer to participate in an incentive program while still not requiring a consumer to view all commercials. Furthermore, it allows the consumer to pick and choose among types of commercials to watch and provides valuable feedback to advertisers as to which commercials consumers are willing to watch. FIGS. 7A and 7B utilize a flowchart 700 to demonstrate a method in accordance with one embodiment of the invention. In block 704, program content that is comprised of non-commercial content and commercial content is transmitted to a consumer. The content is received at a receiver operated by the consumer. The receiver stores the content for later playback. During playback, the consumer can be queried as to whether the consumer wants to play the stored commercial, as shown by block 708. In block 712, a determination is made as to whether the consumer selects playback of the stored commercial. For example, the consumer can select playback via selection of an icon displayed as a graphical user interface on a display screen. As one example shown by block 716, a personal video recorder can be configured to prompt the consumer when a commercial is encountered during playback of stored content and then to cause playback of the commercial if the consumer indicates that he or she wants to watch the commercial, as indicated by block 720. In block 724, a determination can be made that the consumer has played the commercial. Furthermore, block 728 indicates that a report can be made to an advertiser that a consumer (or a group of consumers) watched an advertisement. This can be valuable information to broadcasters, advertisers and others in that it indicates products or categories of commercials for which consumers are willing to view commercials. Finally, block 728 shows that a consumer can be credited with incentive program credit for having played a commercial.

The personal video recorder can optionally be configured to prevent fast forwarding through a commercial if the selects a commercial to view. However, in some instances, one might want to allow a consumer to fast forward through a commercial. This could be indicative of the consumer's reaction to a particularly boring commercial. Furthermore, it might allow a consumer to participate more fully if he/she realized that an opt out was available if a commercial was particularly boring. A consumer might be given no incentive credit or only partial incentive credit when an advertisement was aborted in this manner.

In accordance with another embodiment of the invention, an incentive program can be utilized to obtain feedback about particular commercials from consumers. This type of system requires a transmission medium that can convey transmissions from the consumer to the incentive program or some other party, such as the advertiser or the broadcaster. For example, this might be accomplished by coupling the consumer's receiver or personal video recorder to an open network, such as the internet. Or, it could involve utilizing a cable network system in which a consumer is allowed to transmit signals to a head-end of the cable system. Or, it might involve a consumer system configured with a wireless transmission system for conveying the feedback messages. As one example, FIG. 8 illustrates a flowchart 800 that demonstrates a method of obtaining consumer feedback about a commercial. In block 804, a consumer registers as a participant in an incentive program. In block 812, program content is transmitted to a consumer's receiver and stored for later playback. The consumer may then begin playback of the received program content which includes at least one commercial. When a commercial is played by the consumer, the consumer can be presented with a graphical user interface that queries the consumer about the consumer's reaction to the advertisement. For example, the query can be whether the consumer liked/disliked the product (block 824), liked/disliked the advertisement (block 820), likes/dislikes the advertiser (block 828), likes/dislikes the manufacturer of the product, would like more information about the product, would like to know of a web site to learn more about the product, etc. An input device such as a remote control button can be used to select a response to the query—for example by selecting yes/no options displayed as a graphical user interface on the display screen. The received input can then be saved as immediate feedback from the consumer, as shown by block 816. As noted previously, this information may then be reported to interested parties. Furthermore, the consumer can be credited with additional incentive program credit for this more active level of participation in the incentive program.

Reports may be generated from the consumers' feedback. Thus, advertisers may periodically review the results of their advertising campaigns, including how many people viewed their advertisement (segmented by demographic group, for example) as well as feedback from viewers on the effectiveness of their advertising campaigns.

In accordance with another embodiment of the invention, a consumer may redeem incentive credits that the consumer earned while participating in the incentive program. FIG. 9 illustrates one example of this embodiment in flow chart 900. In block 904, a consumer registers in an incentive program that is configured to provide incentive to a consumer to play advertisements, such as viewing commercials stored on a personal video recorder. In block 908, the consumer is credited with an incentive program credit in response tot the consumer playing an advertisement. In block 912, the consumer may redeem the incentive credit that has been earned. Redemption of incentive program credit may be accomplished in a number of ways. For example, redemption may be accomplished by providing the consumer with additional program content, as illustrated by block 916. As an example of this, a consumer watching a movie could redeem incentive program credit to obtain transmission of behind-the-scenes content that is often distributed with DVD's when movies are released as DVD's. Or, a consumer watching a sporting event could redeem the incentive program credits to obtain continued broadcast coverage of highlights or interviews from the event. As another redemption option, block 920 shows that a consumer can be provided with a coupon. Such a coupon could be provided to a consumer for watching a commercial or for watching a number of commercials or for watching a number of commercial minutes, as detailed by the incentive program rules and conditions. Alternatively, block 924 shows that the consumer could redeem incentive program credit for monetary value.

Consumers could receive a variety of discounts as rewards under an incentive program. For example, a consumer could receive discounts on products or services from merchants, manufacturers, vendors, or service providers. Furthermore, when viewing/listening to a commercial, a coupon could be added to the consumer's account for the product, service, or vendor related to the commercial or to a retailer/distributor of the product or service.

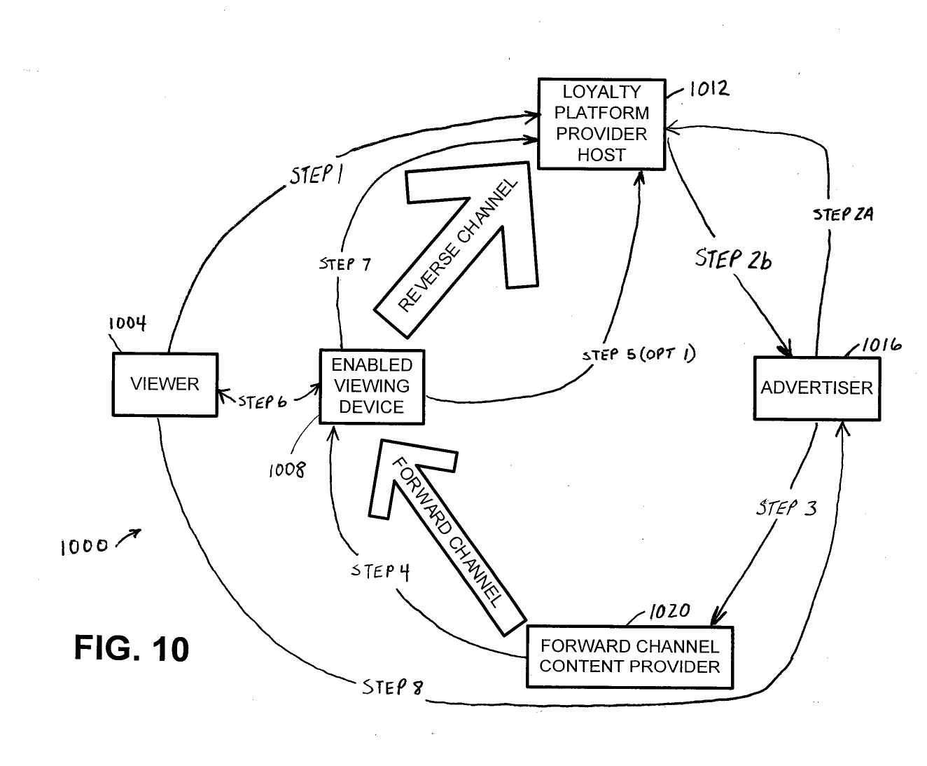

Referring now to FIG. 10, an example of implementing an incentive program in accordance with one embodiment of the invention can be seen. In accordance with this example, the following terms will have the following definitions. A “loyalty program provider host” shall mean a central clearinghouse for creating, processing, and/or redeeming loyalty programs. A “viewer” shall mean a consumer. An “advertiser” shall mean a distributor of a commercial advertisement that is delivered to a viewer. A “loyalty account” shall mean a consumer account with a loyalty program provider host that can obtain promotional credits, such as “coupons” and/or loyalty points, which can be redeemed via an advertiser for example. Such an account can have multiple sub-accounts such as branded loyalty cards. A “forward channel” shall mean a delivery mechanism for delivering video data to a viewing device. This includes but is not limited to aerial television broadcast, cable and satellite television feeds, as well as on-demand video streaming of content over a network such as the internet. “Reverse channel” shall mean a mechanism for communication between a viewing device and a back office system, such as a loyalty program host. For example, this could be accomplished by coupling a viewing device with the back-office system across the internet or by two-way cable transmissions. A “forward channel content provider” shall mean a provider of content for forward-channel, such as a TV network or local TV channel, or cable operator. An “enabled video broadcast viewing device” shall mean a device capable of directly or indirectly displaying broadcast video signal. This could include live-only devices such as television sets or set-top boxes or time shifted viewing devices such as PVR's or on-demand set-top boxes. FIG. 10 shows operation of a loyalty system 1000 for viewing commercials. In step 1, a viewer 1004 creates or links a loyalty account to a viewing device, such as a PVR. In step 2a, an advertiser 1016 creates a promotion coupon offering via a loyalty program provider host 1012. In step 2b, a coupon is assigned a unique ID/sku by the loyalty program provider host. This ID/sku is given to the advertiser. In step 3, the advertiser uses the ID to create and/or provide a commercial to the forward channel content provider 1020 for inclusion in a broadcast. In step 4, a viewing device 1008 is notified with the promotion ID when the advertising airs. Optionally, the advertisement can contain the promotion ID in embedded data via a standard data channel, such as one of the “closed captioning” sub-channels or via additional data on a digital transmission, such as an HDTV transmission. As another option, a list of promotions and air times is provided to the viewing device. In option 1 of step 5, the viewing device can detect the promotion ID when advertising is ready to air. The viewing device can then issue a promotion definition request transaction including promotion ID and viewer account number to the loyalty program provider host. In response, the viewing device can receive a specific offering for this viewer based on the viewer's profile and the advertiser's specifications. Alternatively, as a second option in step 5, the viewing device can detect the promotion ID of the advertisement that is about to air and utilize basic promotion parameters stored by the viewing device. In step 6, the viewing device generates a visual of an offering, such as a graphical user interface, and superimposes the offer in the space provided in the video commercial. The viewer is offered an option via remote control buttons to either signal acceptance of the offering or signal non-acceptance of the offer. In step 7, if a positive or negative response was received, an appropriate transaction is composed and sent to the loyalty program provider host. A positive response will result in the offering being added to the viewer loyalty account or sub-account. A negative response may be passed through to the advertiser. Both responses may also be used as a transaction of its own to earn participation points from the loyalty program provider host forward channel content provider. At a later time, the viewer may redeem the promotions accumulated in the account based on promotion rules using account card(s).

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. A method comprising:
registering a consumer in an incentive program, said incentive program configured to incite a consumer to play an advertisement;
transmitting program content comprising non-commercial content and a commercial to a content receiver operated by a consumer, wherein said content receiver is configured to store said non-commercial content as stored non-commercial content and configured to store said commercial as a stored commercial for later playback;
determining that said consumer played said stored commercial;
crediting to said consumer an incentive program credit in return for said consumer playing said commercial.

2. The method as claimed in claim 1 wherein said transmitting said commercial to said content receiver comprises:
transmitting said commercial to a personal video recorder.

3. The method as claimed in claim 1 wherein said determining comprises:
receiving a signal from said content receiver indicating that said consumer played said stored commercial.

4. The method as claimed in claim 1 wherein said crediting said consumer comprises:
increasing an incentive program point total for said consumer.

5. The method as claimed in claim 1 wherein said crediting said consumer comprises:
crediting said consumer with a coupon.

6. The method as claimed in claim 1 wherein said crediting said consumer comprises:
providing said consumer with access to additional non-commercial content.

7. The method as claimed in claim 1 wherein said crediting said consumer comprises:
crediting said consumer with monetary value.

8. A method comprising:
registering a consumer in an incentive program;
providing said consumer with a list of categories of commercials that said consumer can view under said incentive program;
receiving from said consumer a set of selected categories of commercials;
associating said set of selected categories of commercials with an identifier for said consumer in a computer database.

9. The method as claimed in claim 8 and further comprising:
determining an advertisement that matches at least one category in said set of selected categories for said consumer;
incorporating said advertisement in a transmission of program content to said consumer.

10. The method as claimed in claim 9 and further comprising:
determining whether said consumer played said advertisement.

11. The method as claimed in claim 10 and further comprising:
crediting said consumer with incentive credit in return for said consumer playing said advertisement.

12. The method as claimed in claim 9 and further comprising:
obtaining demographic data of the consumer;
reporting said demographic data of said consumer to an advertiser associated with said advertisement.

13. A method comprising:
receiving program content comprising non-commercial content and a commercial at a content receiver operated by a consumer, wherein said content receiver is configured to store said non-commercial content as stored non-commercial content and configured to store said commercial as a stored commercial for later playback;
querying said consumer during playback of said non-commercial content as to whether said consumer wants to play said stored commercial;
determining that said consumer has selected playback of said stored commercial;
playing said stored commercial.

14. The method as claimed in claim 13 and further comprising:
determining that said consumer played said stored commercial;
crediting to said consumer an incentive program credit in return for said consumer playing said commercial.

15. The method as claimed in claim 13 wherein a personal video recorder is utilized to determine that said consumer has selected playback of said stored commercial.

16. The method as claimed in claim 13 and further comprising:
reporting to an advertiser that said consumer played said commercial.

17. A method comprising:
registering a consumer in an incentive program, said incentive program configured to incite said consumer to play an advertisement;
transmitting program content comprising non-commercial content and a commercial to a content receiver operated by a consumer, wherein said content receiver is configured to store said non-commercial content as stored non-commercial content and configured to store said commercial as a stored commercial for later playback;
receiving immediate feedback from said consumer in response to playback of said stored commercial.

18. The method as claimed in claim 17 wherein said feedback comprises feedback about said commercial.

19. The method as claimed in claim 17 wherein said feedback comprises feedback about a product or service advertised in said commercial.

20. The method as claimed in claim 17 wherein said feedback comprises feedback about an advertiser associated with said commercial.

21. A method comprising:
registering a consumer in an incentive program, said incentive program configured to incite said consumer to play an advertisement;
crediting said consumer with incentive program credit in response to said consumer playing said advertisement;
redeeming said incentive program credit.

22. The method as claimed in claim 21 wherein said redeeming comprises:
providing said consumer with additional program content.

23. The method as claimed in claim 21 wherein said redeeming comprises:
providing said consumer with a coupon.

24. The method as claimed in claim 21 wherein said redeeming comprises:
providing said consumer with monetary value.
